(19) United States
(12) Patent Application Publication
(10) Pub. No.: US 2005/0202195 A1
(43) Pub. Date: Sep. 15, 2005

(54) Tape device

(76) Inventor: Susan Lawrence, Hillsboro, WI (US)

Correspondence Address: DAVID J. ARCHER, 7037 POMERY ROAD, ROCKTON, IL, 61072, US

(21) Appl. No.: 10/799,832

(22) Filed: Mar. 13, 2004

(51) Int. Cl. B32B 9/00

(52) U.S. Cl. 428/40.1; 428/41.8

(57) ABSTRACT

A tape device is disclosed for assisting in a picture hanging, picture matting, sewing, craft, home improvement and stenciling project. The device includes a roll of tape having a first and a second end, a first and a second edge and a first and a second surface. A coating of releasable adhesive is disposed on at least one of the surfaces of the tape for permitting a releasable attachment of the tape to the project. Measuring indicia are printed along the tape between the first and the second ends thereof, the indicia permitting a user to determine a distance between locations spaced relative to each other along the tape. The indicia are printed on at least a surface of the tape which is disposed opposite to the at least one surface having the coating thereon. The arrangement is such that in use of the tape, the tape is applied to the project so that the tape temporarily adheres to the project so that the measuring indicia permits the correct positioning of the locations on the project.

### BACKGROUND OF THE INVENTION

1. Field of the Invention

The present invention relates to a tape device for assisting in a picture hanging, picture matting, sewing, craft, home improvement and stenciling project. More particularly, the present invention relates to a measuring tape device for assisting in a picture hanging, picture matting, sewing, craft, home improvement and stenciling project.

2. Background Information

Many projects such as a picture hanging project can be time consuming and frustrating because it is difficult to hang a series of pictures on a wall with equal spaces therebetween. More specifically, if for example, four pictures of equal size are to be hung on a wall as a group, the relative locations for the hanging fasteners is difficult to determine.

The present invention overcomes the aforementioned problem by the provision of low tack adhesive tape which is marked off with measuring indicia so that the picture hanging project can be greatly simplified.

Therefore, a primary feature of the present invention is the provision of a tape device for assisting in a picture hanging, picture matting, sewing, craft, home improvement and stenciling project that overcomes the problems associated with the prior art arrangements.

Another feature of the present invention is the provision of a tape device for assisting in a picture hanging, picture matting, sewing, craft, home improvement and stenciling project that greatly simplifies the aforementioned projects.

A further feature of the present invention is the provision of a tape device for assisting in a picture hanging, picture matting, sewing, craft, home improvement and stenciling project that is relatively easy to manufacture.

Other features and advantages of the present invention will be readily apparent to those skilled in the art by a consideration of the detailed description of a preferred embodiment of the present invention contained herein.

### SUMMARY OF THE INVENTION

The present invention relates to a tape device for assisting in a picture hanging, picture matting, sewing, craft, home improvement and stenciling project. The tape device includes a roll of tape having a first and a second end, a first and a second edge and a first and a second surface. A coating of releasable adhesive is disposed on at least one of the surfaces of the tape for permitting a releasable attachment of the tape to the project. Measuring indicia are printed along the tape between the first and the second ends thereof, the indicia permitting a user to determine a distance between locations spaced relative to each other along the tape. The indicia are printed on at least a surface of the tape which is disposed opposite to the at least one surface having the coating thereon. The arrangement is such that in use of the tape, the tape is applied to the project so that the tape temporarily adheres to the project so that the measuring indicia permits the correct positioning of the locations on the project.

In a more specific embodiment of the present invention, the tape is flexible and the tape is fabricated from paper.

Furthermore, the tape defines a distance between the first and second edges thereof within a range 3/4 inches to 1 inch.

In another embodiment of the present invention, the tape defines a distance between the first and second edges thereof within a range 3/8 inches to 5/8 inch.

In yet another embodiment of the present invention, the tape defines a distance between the first and second edges thereof within a range 1/8 inches to 3/8 inch.

Additionally, in one embodiment of the present invention, the coating of releasable adhesive is disposed on both the first and the second surface of the tape.

In a preferred embodiment of the present invention, the coating is of a low tack adhesive such that after using the measuring indicia for determining the relative position of the locations on the project, removal of the tape from the project is permitted.

Also, the measuring indicia includes a first series of measurements which are disposed along the tape. The first series of measurements are disposed along the tape are indicated in inches. However, a second series of measurements are disposed along the tape in centimeters.

More specifically, the first series of measurements is disposed adjacent to one of the edges of the tape and the second series of measurements is disposed adjacent to an edge of the tape opposite to the other edge.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a top plan view of a tape device according to the present invention, for assisting in a picture hanging, picture matting, sewing, craft, home improvement and stenciling project;

FIG. 2 is a side elevational view of the tape device shown in FIG. 1 but showing the roll of tape partially unrolled;

FIG. 3 is a sectional view taken on the line 3-3 of FIG. 2;

FIG. 4 is a side elevational view illustrating an application of the tape device shown in FIGS. 1-3 to a project such as a picture hanging project; and

FIG. 5 shows the steps required in order to achieve the symmetrical disposition of the pictures shown in FIG. 4 onto a wall.

Similar reference characters refer to similar parts throughout the various views of the drawings.

### DETAILED DESCRIPTION OF THE DRAWINGS

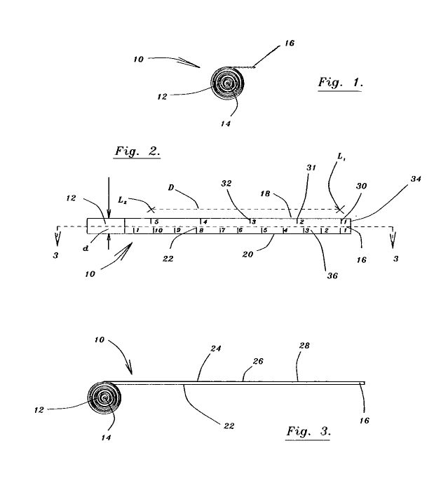

FIG. 1 is a top plan view of a tape device according to the present invention, for assisting in a picture hanging, picture matting, sewing, craft, home improvement and stenciling project. As shown in FIG. 1, the tape device generally designated 10 includes a roll of tape 12 having a first and a second end 14 and 16 respectively.

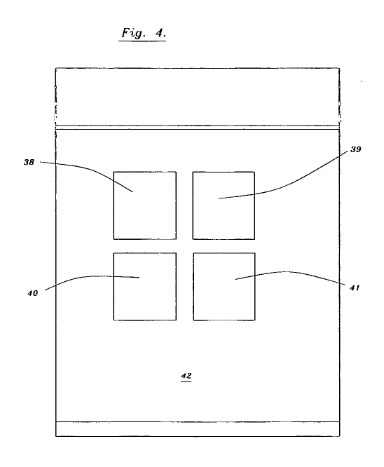

FIG. 2 is a side elevational view of the tape device 10 shown in FIG. 1 but showing the roll of tape 12 partially unrolled. As shown in FIG. 2, the tape device 10 has a first and a second edge 18 and 20 respectively and a first surface 22.

FIG. 3 is a sectional view taken on the line 3-3 of FIG. 2. As shown in FIG. 3, the tape 12 has a second surface 24. A coating 26 of releasable adhesive 28 is disposed on at least one of the surfaces 22 or 24 of the tape 12 for permitting a releasable attachment of the tape 12 to the project. As shown in FIG. 2, measuring indicia 30, 31 and 32 are printed along the tape 12 between the first and the second ends 14 and 16 thereof, the indicia 30-32 permitting a user to determine a distance D between locations L₁ and L₂ spaced relative to each other along the tape 12. The indicia 30-32 are printed on at least a surface such as the first surface 22 of the tape 12 which is disposed opposite to the at least one surface such as the second surface 24 having the coating 26 thereon. The arrangement is such that in use of the tape 12, the tape 12 is applied to the project so that the tape 12 temporarily adheres to the project so that the measuring indicia 30-32 permit the correct positioning of the locations L₁ and L₂ on the project.

In a more specific embodiment of the present invention, the tape 12 is flexible and is fabricated from paper.

Furthermore, the tape 12 defines a distance d between the first and second edges 18 and 20 thereof within a range 3/4 inches to 1 inch.

In another embodiment of the present invention, the tape 12 defines a distance d between the first and second edges 18 and 20 thereof within a range 3/8 inches to 5/8 inch.

In yet another embodiment of the present invention, the tape 12 defines a distance between the first and second edges 18 and 20 thereof within a range 1/8 inches to 3/8 inch.

More specifically, the tape may have a width d of ⅞″, ½″ or ¼″.

Additionally, in one embodiment of the present invention, the coating 26 of releasable adhesive 28 is disposed on both the first and the second surface 22 and 24 of the tape 12.

In a preferred embodiment of the present invention, the coating 26 is of a low tack adhesive 28 such that after using the measuring indicia 30-32 for determining the relative positions of the locations L₁ and L₂ on the project, removal of the tape 12 from the project is permitted.

Also, the measuring indicia 30-32 include a first series of measurements 34 which are disposed along the tape 12. The first series of measurements 34 are disposed along the tape 12 and are indicated in inches. However, a second series of measurements 36 are disposed along the tape 12 indicated in centimeters.

More specifically, the first series of measurements 34 is disposed adjacent to one of the edges such as edge 18 of the tape 12 and the second series of measurements 36 is disposed adjacent to an edge of the tape such as 20 disposed opposite to the edge 18.

FIG. 4 is a side elevational view illustrating an application of the tape device 10 to a project such as a picture hanging project. As shown in FIG. 4, the project entails hanging four pictures 38, 39, 40 and 41 symmetrically onto a wall 42.

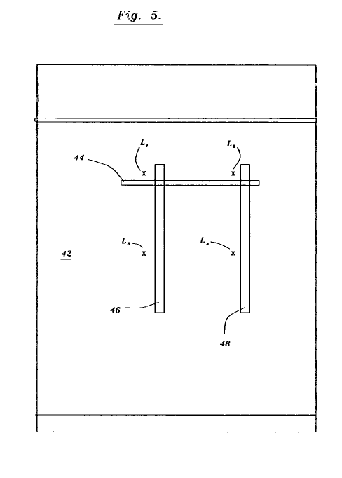

FIG. 5 shows the steps required in order to achieve the symmetrical disposition of the pictures 39-41 on the wall 42. For example, if each of the pictures 38-41 has a width of 12″ and a height of 18″, a length 44 of tape 12 is unrolled and cut to a length of 27″ if the pictures are to be spaced apart side by side by a distance of 3″. That is 12″ plus 3″ plus 12″. The 27″ length 44 of tape 12 is then pressed against the wall 42 so that the length 44 of tape 12 extends horizontally along the wall 42. The locations L₁ and L₂ are then marked on the wall 42 adjacent to the 6″ and 21″ indicia on the tape so that suitable picture hanging hooks can be fastened to the wall 42 adjacent to such 6″ and 21″ indicia at locations L₁ and L₂.

Next, a length 46 of tape 12 which is 39″ long is cut from the roll of tape. The length 46 of tape is 18″ plus 3″ plus 18″. One end of the 39″ length of tape is then pressed onto the wall 42 3″ above the location L₁ so that the 39″ length extends vertically downwardly from the location L₁. The process is repeated using a further 39″ length 48 of tape extending vertically downwardly from 3″ above the second location L₂. Further picture hanging hooks are then fastened to the wall 42 adjacent to the 24″ indicia on the two 39″ lengths 46 and 48 assuming that each of the pictures is to be hung 3″ below the top horizontal edge of the picture so that the further hooks are disposed at locations L₃ and L₄.

The 27″ length 44 and the two 39″ lengths 46 and 48 of tape are then released from the wall 42 by gently peeling such lengths of tape from the wall 42 thus leaving the four hooks secured to the wall 42. The four pictures 39-41 are then hung on the respective hooks so that each picture will be spaced exactly 3″ vertically and horizontally from an adjacent picture as shown in FIG. 4.

The same principle with regard to the aforementioned picture hanging project can be equally applied to mounting a picture or photograph symmetrically within a matting frame.

Also, in a sewing project, if for example, buttons are to be sewn at regular intervals along a garment, a length of tape 12 can be temporarily attached to the cloth and the relative required disposition of such buttons can be marked onto the cloth using the tape indicia. When the buttons have been attached, the tape is then removed from the garment.

Similarly, the tape device 10 can be applied to a pleating project such as a pleated skirt or the like so that by the application of the tape to the cloth, the exact location for each successive pleat can be determined.

The tape according to the present invention finds numerous and diverse applications in various home improvement projects and enables a user to accurately locate a stencil for use in a decorating project and the like.

The tape according to the present invention enables the user to releasably fasten the tape to the project while the necessary measurements are taken and marked onto the project so that the tape can subsequently be removed from the project while leaving the permanent location marked on the project.

1. A tape device for assisting in a picture hanging, picture matting, sewing, craft, home improvement and stenciling project, said device comprising:
a roll of tape having a first and a second end, a first and a second edge and a first and a second surface;
a coating of releasable adhesive disposed on at least one of said surfaces of said tape for permitting a releasable attachment of said tape to the project; and
measuring indicia printed along said tape between said first and said second ends thereof, said indicia permitting a user to determine a distance between locations spaced relative to each other along said tape, said indicia being printed on at least a surface of said tape which is disposed opposite to said at least one surface having said coating thereon, the arrangement being such that in use of said tape, said tape is applied to the project so that said tape temporarily adheres to the project such that said measuring indicia permits the correct positioning of said locations on the project.

2. A tape device as set forth in claim 1 wherein
said tape is flexible.

3. A tape device as set forth in claim 1 wherein
said tape fabricated from paper.

4. A tape device as set forth in claim 1 wherein
said tape defines a distance between said first and second edges thereof within a range 3/4 inches to 1 inch.

5. A tape device as set forth in claim 1 wherein
said tape defines a distance between said first and second edges thereof within a range 3/8 inches to 5/8 inch.

6. A tape device as set forth in claim 1 wherein
said tape defines a distance between said first and second edges thereof within a range 1/8 inches to 3/8 inch.

7. A tape device as set forth in claim 1 wherein
said coating of releasable adhesive is disposed on both said first and said second surface of said tape.

8. A tape device as set forth in claim 1 wherein
said coating is of a low tack adhesive such that after using said measuring indicia for determining the relative position of said locations on the project, removal of said tape from the project is permitted.

9. A tape device as set forth in claim 1 wherein
said measuring indicia includes:
a first series of measurements disposed along said tape.

10. A tape device as set forth in claim 9 wherein
said first series of measurements disposed along said tape is in inches;
said measuring indicia including:
a second series of measurements disposed along said tape in centimeters.

11. A tape device as set forth in claim 10 wherein
said first series of measurements is disposed adjacent to one of said edges of said tape;
said second series of measurements is disposed adjacent to an edge of said tape opposite to said one of said edges.

12. A tape device for assisting in a picture hanging, picture matting, sewing, craft, home improvement and stenciling project, said device comprising:
a roll of tape having a first and a second end, a first and a second edge and a first and a second surface;
a coating of releasable adhesive disposed on at least one of said surfaces of said tape for permitting a releasable attachment of said tape to the project;
measuring indicia printed along said tape between said first and said second ends thereof, said indicia permitting a user to determine a distance between locations spaced relative to each other along said tape, said indicia being printed on at least a surface of said tape which is disposed opposite to said at least one surface having said coating thereon, the arrangement being such that in use of said tape, said tape is applied to the project so that said tape temporarily adheres to the project so that said measuring indicia permits the correct positioning of said locations on the project; and
said coating being of a low tack adhesive such that after using said measuring indicia for determining the relative position of said locations on the project, removal of said tape from the project is permitted.

13. A tape device for assisting in a picture hanging, picture matting, sewing, craft, home improvement and stenciling project, said device comprising:
a roll of tape having a first and a second end, a first and a second edge and a first and a second surface;
a coating of releasable adhesive disposed on at least one of said surfaces of said tape for permitting a releasable attachment of said tape to the project;
measuring indicia printed along said tape between said first and said second ends thereof, said indicia permitting a user to determine a distance between locations spaced relative to each other along said tape, said indicia being printed on at least a surface of said tape which is disposed opposite to said at least one surface having said coating thereon, the arrangement being such that in use of said tape, said tape is applied to the project so that said tape temporarily adheres to the project so that said measuring indicia permits the correct positioning of said locations on the project;
said tape being flexible;
said tape being fabricated from paper;
said tape defining a distance between said first and second edges thereof within a range 1/8 inches to 1 inch;
said coating being of a low tack adhesive such that after using said measuring indicia for determining the relative position of said locations on the project, removal of said tape from the project is permitted;
said measuring indicia including:
a first series of measurements disposed along said tape;
said first series of measurements disposed along said tape being in inches;
said measuring indicia including:
a second series of measurements disposed along said tape in centimeters;
said first series of measurements being disposed adjacent to one of said edges of said tape; and
said second series of measurements being disposed adjacent to an edge of said tape opposite to said one of said edges.
